(19) United States
(12) Patent Application Publication
(10) Pub. No.: US 2018/0101850 A1
(43) Pub. Date: Apr. 12, 2018

(54) USER AND DEVICE AUTHENTICATION FOR WEB APPLICATIONS

(71) Applicant: Microsoft Technology Licensing, LLC, Redmond, WA (US)

(72) Inventors: Matthias Bernard Pisut, IV, Issaquah, WA (US); Jonathan Lee Cutler, Seattle, WA (US); Michael William Stark, Renton, WA (US)

(21) Appl. No.: 15/675,254

(22) Filed: Aug. 11, 2017

Related U.S. Application Data
(63) Continuation-in-part of application No. 15/674,963, filed on Aug. 11, 2017.
(60) Provisional application No. 62/407,169, filed on Oct. 12, 2016.

(51) Int. Cl. G06Q 20/40; H04L 29/06; G06F 21/31

(52) U.S. Cl. CPC G06Q 20/4014; G06Q 20/12; G06F 21/31; H04L 63/08

(57) ABSTRACT

A computing device supports a Web Authentication (WebAuthN) application program interface (API) that is configured to exposes functionalities that may substitute for those utilized in the EMV (Europay, Mastercard, and Visa) standard for transactions using smart payment instruments like debit and credit cards that include embedded computer chips. The functionality of the WebAuthN-compliant computing device is analogous to a physical card in the conventional chip and PIN (personal identification number) where the chip serves as proof of payment device and the PIN as proof of payment account holder.

### STATEMENT OF RELATED APPLICATIONS

This application is a continuation in part of U.S. Ser. No. 15/674,963; filed Aug. 11, 2017, entitled “USER AND DEVICE AUTHENTICATION FOR WEB APPLICATIONS,” which claims benefit and priority to U.S. Provisional Application Ser. No. 62/407,169 filed Oct. 12, 2016, entitled “User and Device Authentication for Web Applications” which is incorporated herein by reference in its entirety.

### BACKGROUND

Users of computing devices such as smartphones, tablets, wearable-computing devices, and personal computers often need to interact with web applications and other online resources in a manner in which the user is authenticated to enhance security and minimize the opportunities for problems such as impersonation and fraud.

### SUMMARY

A computing device supports a Web Authentication (WebAuthN) application program interface (API) that is configured to expose functionalities that may substitute for those utilized in the EMV (Europay, Mastercard, and Visa) standard for transactions using smart payment instruments like debit and credit cards that include embedded computer chips. The functionality of the WebAuthN-compliant computing device is analogous to a physical card in the conventional chip and PIN (personal identification number) where the chip serves as proof of payment device and the PIN as proof of payment account holder.

The WebAuthN API is compliant with portions of the WebAuthentication protocol formerly referred to as FIDO 2.0 (Fast Identity Online) which describes an interoperable way of performing online authentication using biometric devices across web browser applications. When WebAuthN is configured as an EMV substitute, its capabilities are leveraged to perform a personalization process to cryptographically bind the computing device to a device user (i.e., the payment account holder). The personalization process parallels the EMV activities of ID and verification (ID&V) and can be performed in a WebAuthN implementation supported by a financial institution such as a bank. The bank's WebAuthN implementation is configured to support both authentication and authorization workflows.

In authentication, the bank establishes presence of the payment account holder using, for example, two-factor authentication. WebAuthN implements a makeCredential workflow on the WebAuthN-compliant computing device in which the private portion of a keypair is protected by the device and the public portion is delivered to the bank for subsequent verification. The WebAuthN key thus acts as a substitute for the EMV physical card keys for example, Limited Use Keys (LUK), Single Use Keys (SUK) and Card Master Keys (CMK). Attestation may also be implemented by WebAuthN using a getAttestation workflow to further strengthen the binding between the computing device and the user.

During a transaction, for example with a web-based merchant (i.e., the payee), when the WebAuthN-compliant computing device user signals an intent to pay, the device essentially functions as the payee's EMV terminal. A host associated with the website/payee issues a generate application cryptogram (AC) command to the WebAuthN-compliant computing device which initiates authentication with the bank. An existing WebAuthN keypair may be utilized or a new personalization process can be undertaken to establish a trust relationship. The makeCredential/getAttestation workflows cause the WebAuthN-compliant computing device to challenge the user for evidence of presence when signing over transaction details and/or other proprietary information required by the bank. This challenge mimics a conventional EMV terminal request for the user to enter a PIN or provide a signature.

If authentication is successful, the WebAuthN-compliant computing device generates a payment cryptogram through WebAuthN to the host that emulates the way a chip-enabled card signs over transaction details in a conventional EMV process. The payment cryptogram may be used by the payee for payment authorization to receive funds. Alternatively, the WebAuthN-compliant device can deliver the payment cryptogram directly to the bank to thereby emulate the operations of an EMV terminal.

A given WebAuthN implementation can be customized and tailored to meet particular needs. For example, the financial institutions can dynamically or automatically impose particular security measures, such as certain methods of encryption, and perform analyses of the computing devices that initiate a transaction. WebAuthN can also support heightened security compared with EMV standards. For example, conventional credit or debit cards are typically limited due to memory and processing constraints of the embedded chip. In contrast, the WebAuthN API may be implemented on a fully equipped computing device with specialized hardware for security (e.g., cryptoprocessors), and can be updated over a network. WebAuthN thus enables functional parity with EMV while providing more flexibility and security across multiple e-commerce scenarios.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows an illustrative environment in which user computing devices communicate with an authentication service and a host over a network;

FIGS. 2A-B show an illustrative interaction between a computing device and the authentication service;

FIG. 3 shows an illustrative user experience on the computing device;

FIGS. 4A-B show illustrative actions performed among the computing device, host, and authentication service during a transaction;

FIG. 5 shows a taxonomy of additional security information associated with a WebAuthN API on the computing device;

FIG. 6 shows a taxonomy of additional security criteria for the authentication service;

FIGS. 7-9 show illustrative methods respectively performed by a computing device, host, and authentication service;

FIG. 10 is a simplified block diagram of an illustrative computer system such as a personal computer (PC) that may be used in part to implement the present user and device authentication for web applications;

FIG. 11 shows a block diagram of an illustrative device that may be used in part to implement the present user and device authentication for web applications;

FIG. 12 is a block diagram of an illustrative device such as a mobile phone or smartphone; and

FIG. 13 is a block diagram of an illustrative multimedia console.

Like reference numerals indicate like elements in the drawings. Elements are not drawn to scale unless otherwise indicated.

### DETAILED DESCRIPTION

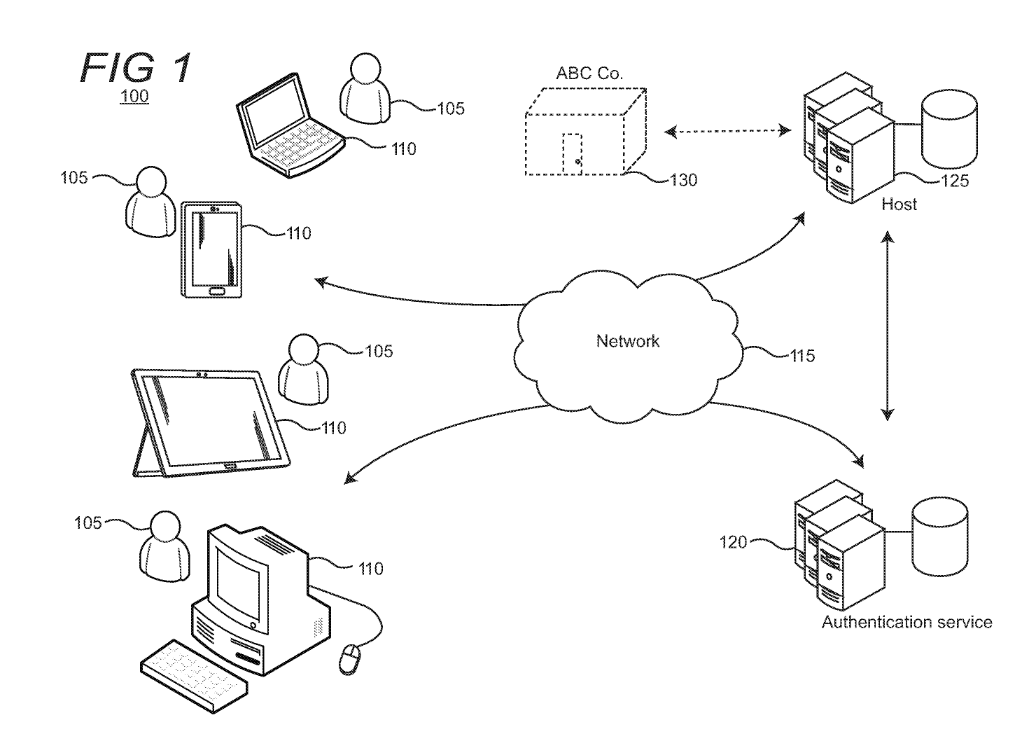

FIG. 1 shows an illustrative environment 100 of various computing devices 110 associated with respective users 105, configured with network capabilities to communicate with an authentication service 120 and a website host 125, which are both supported on one or more servers. The various devices and servers can communicate with each other over network 115. The network can include any type or collection of networks, such as a personal area network, local area network, wide area network, or the Internet. Thus, each of the devices may be configured with Bluetooth, Wi-Fi, or hardwired (e.g., Ethernet cables) to transmit and receive signals, messages, etc.

The computing devices 110 can include, for example, smartphones, tablets, PCs (personal computers), laptops, gaming consoles, or the like. The various devices in the environment can support different features, functionalities, and capabilities (here referred to generally as “features”). Some of the features supported on a given device can be similar to those supported on others, while other features may be unique to a given device. The degree of overlap and/or distinctiveness among features supported on the various devices 110 can vary by implementation. For example, some devices 110 can support touch controls, gesture recognition, and voice commands, while others may enable a more limited user interface. Some devices may support video consumption and Internet browsing, while other devices may support more limited media handling and network interface features.

Furthermore, the computing devices 110 may access the host 125 over the network 115, or alternatively the host 125 may be accessed when a user is at a brick and mortar store, such as ABC Co. 130. For example, the user 105 may be at ABC Co., or any store, where the user wishes to execute a transaction, such as a transaction for goods or services. In response, ABC Co. may provide access to the host 125, such as over the network, which thereby puts the computing device 110 associated with the user in communication with the host 125. Thus, the servers associated with the host 125 may be on-site at ABC Co., or may be accessible by another computing device at ABC Co.

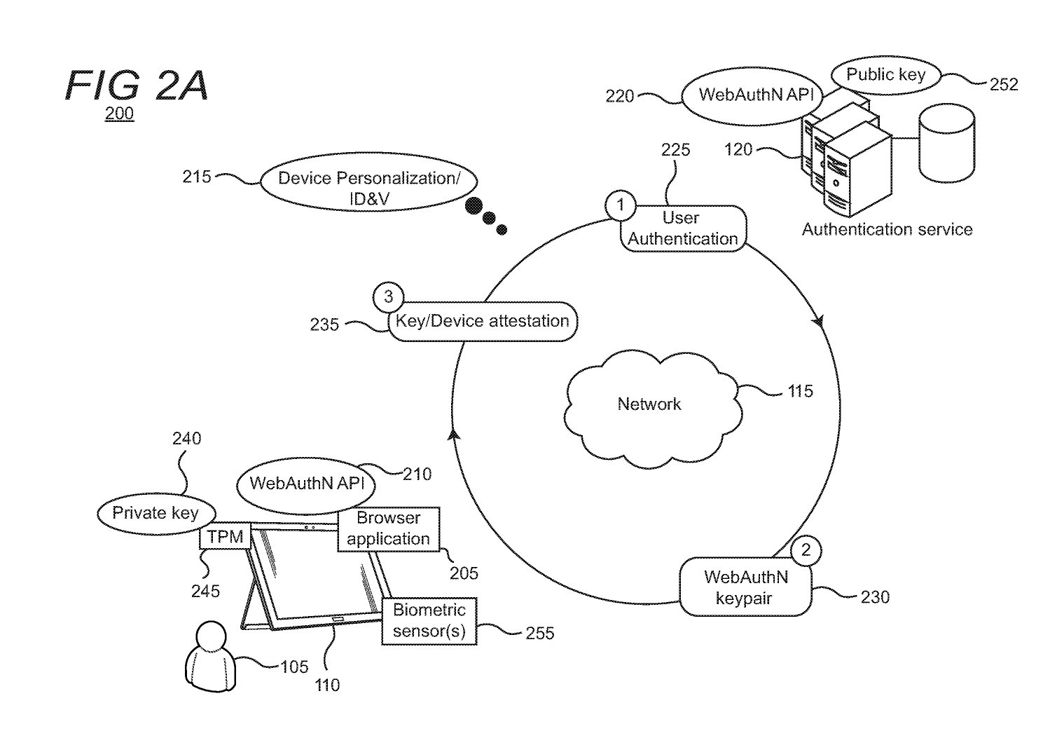

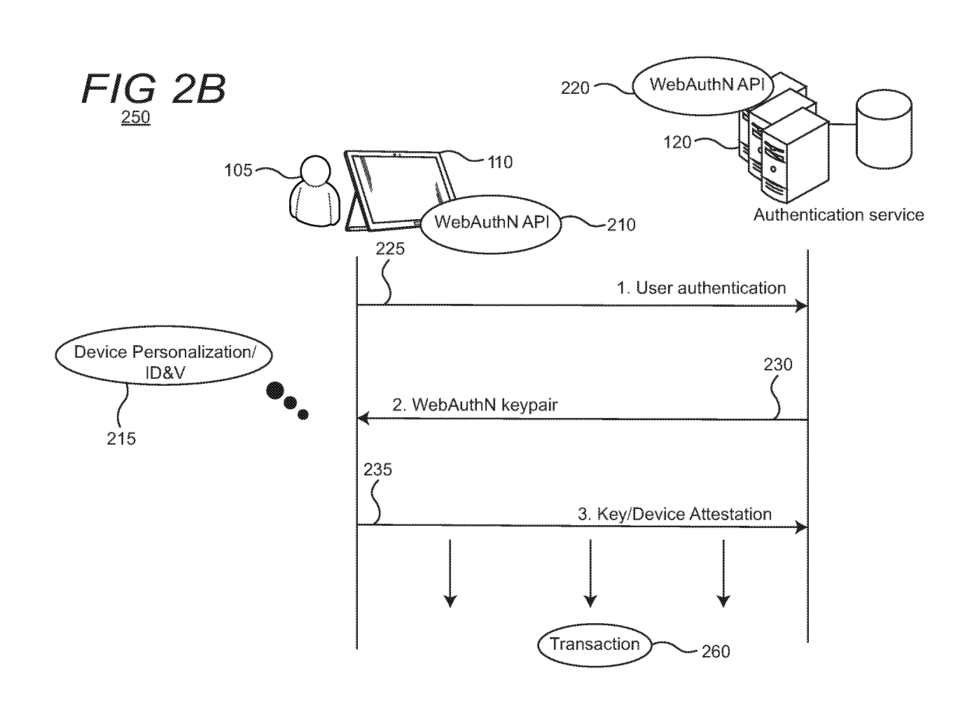

FIGS. 2A-B show exemplary architectures 200 and 250 in which the computing device 110 is personalized with the authentication service 120 over network 115. The device may include various applications, including a browser application 205 that allows the user to access websites on the Internet. The browser application can include WebAuthN capabilities, including a WebAuthN API 210 as a method for device personalization/identification and verification (ID&V) 215. For example, the WebAuthN API may be utilized as a method to authenticate the device that accesses the authentication service. The WebAuthN provides a method in which the service can verify that the computing device used to access the service is an authorized computing device associated with a particular user account. Every time a new device is personalized, the authorization service can transmit a notification or e-mail to the user account so that the user is aware of a newly authorized device.

The authentication service 120 may request user authentication 225 to authenticate the user accessing an account. For example, this may include a two-factor authentication strategy, such as a username and password and then notice to the user's e-mail account. Alternatively, any number of authentication techniques and combinations may be employed, such as a PIN, pattern input, biometric data using biometric sensors 255 such as fingerprint scan, iris scan, face recognition, voice recognition, etc.

After the user 105 has been authenticated by the authentication service 120, the WebAuthN API 210 may correspond with a WebAuthN API 220 of the authentication service to ID&V the computing device 110 utilized by the user. The WebAuthN API 210 may generate a WebAuthN asymmetric keypair 230 (e.g., private key 240 and public key 252). The private key may be stored in a secure cryptoprocessor, including a trusted platform module (TPM) 245. If the computing device does not support any hardware to store the private key, then the private key may alternatively be stored in software.

When the WebAuthN keypair is generated, a key/device attestation 235 process is implemented. Specifically, for the device attestation the public key 252 is transmitted over the network 115 to the authentication service for storage. This provides an authentication of the WebAuthN keypair, so that the authentication service can now authenticate that particular device associated with the private key, which is stored cryptographically. The private key is not transmitted to the authentication service and is only stored on the computing device that went through the personalization process. The device may be authenticated when the device transmits a digital signature using the private key, which can only be decrypted by the public key.

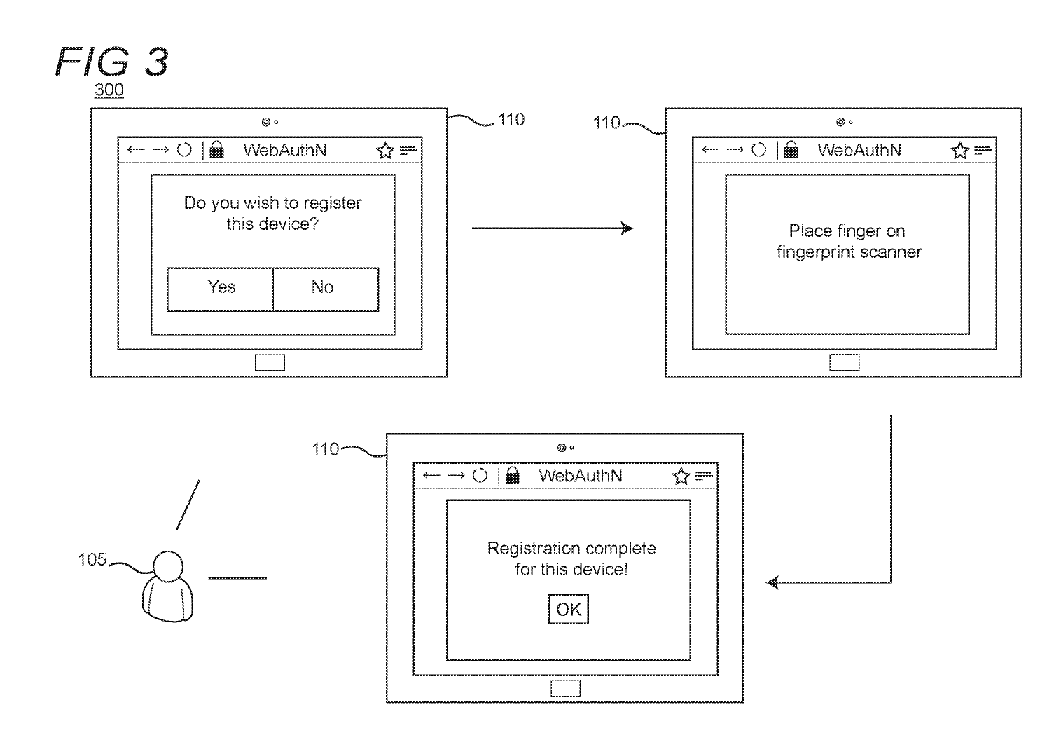

As shown in FIG. 2B, after the personalization process is complete for the device, the user may perform a transaction 260 associated with the established account. FIG. 3 shows a high-level environment 300 in which a display of the device verifies a fingerprint associated with a user, and then subsequently registers that device after executing the WebAuthN keypair 230 and key/device attestation 235 steps of FIGS. 2A-B.

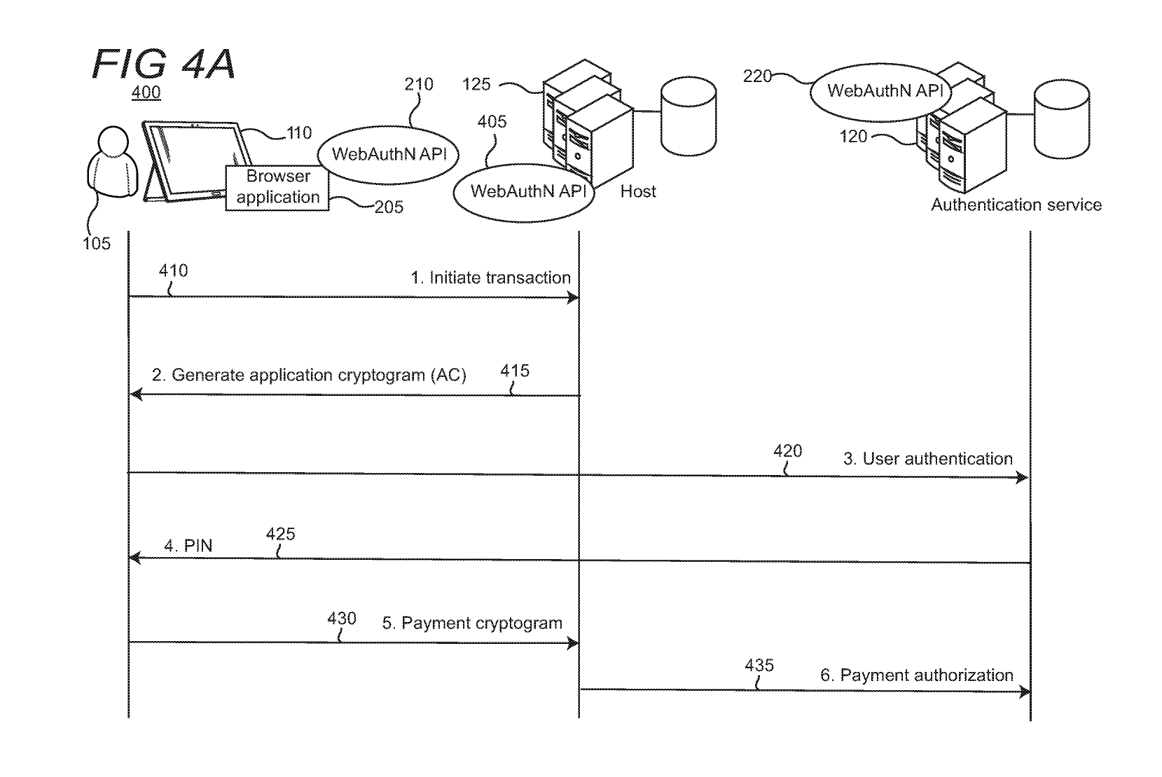

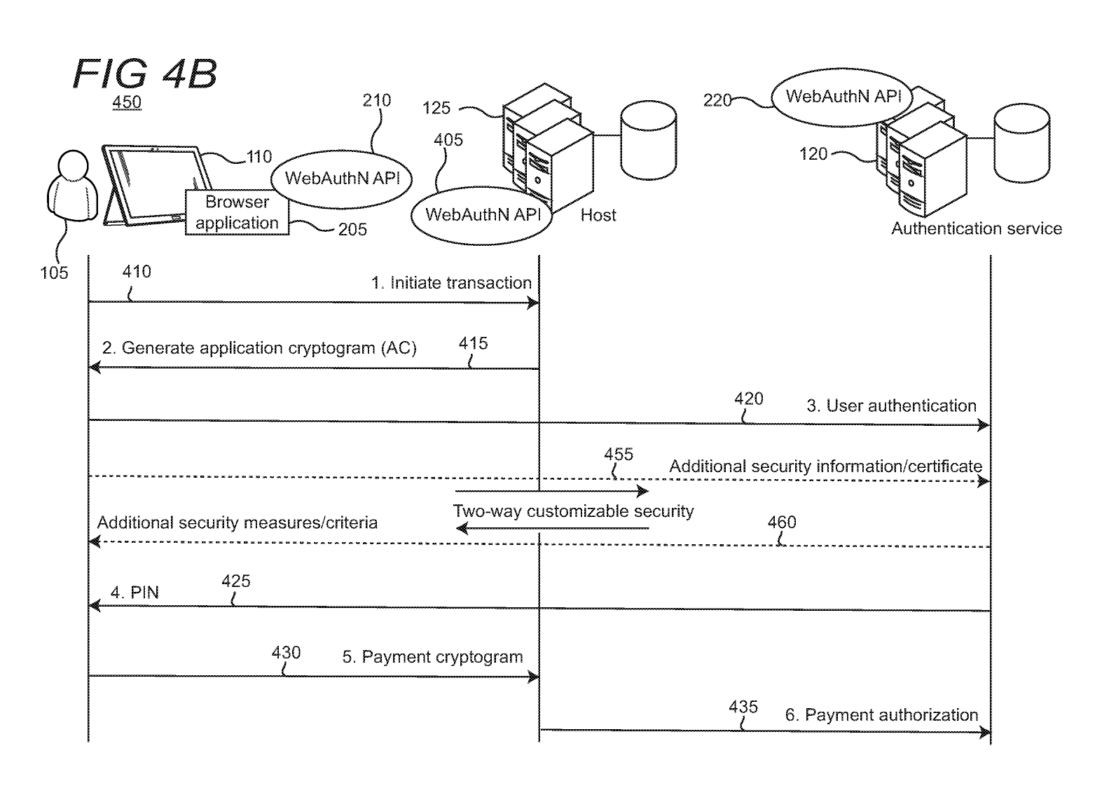

FIG. 4A shows an illustrative interaction 400 among the computing device 110, host 125, and authentication service 120. As illustrated in FIGS. 4A and 4B, the host 125 may also be configured with a WebAuthN API 405, which communicates and interoperates with the WebAuthN APIs 210 and 220 of the computing device and authentication service, respectively. Furthermore, the various devices and servers may communicate over the network, but the user may alternatively be located at an actual establishment such as a brick and mortar store (e.g., ABC Co.) (FIG. 1).

The user may access a website associated with the host 125, and accordingly initiate a transaction (e.g., to purchase goods and/or services) 410. The initiation of the transaction may include the user's intent to pay for the goods or services. Subsequently, the host may transmit a request for an application cryptogram (AC), which is generated by the computing device 415. The AC may, for example, provide details about the transaction. Typically, in chip and PIN transactions implemented over the EMVCo standards, the AC may indicate whether to execute the transaction online (direct communication with card issuer) and if the transaction was declined or approved, among other things. In the context of the WebAuthN protocols and API, the transactions may be performed online so that the authentication service can authenticate the veracity of the transaction (e.g., the computing device and the user).

The device may transmit the generated AC with user authentication 420 data to the authentication service 120, so that the service can properly authenticate the device. At this stage, the WebAuthN protocol encrypts a digital signature with the previously generated private key, which was developed during the personalization process (FIGS. 2A-B). The encrypted digital signature may be transmitted to the service to authenticate the computing device. Specifically, the digital signature is verified with the corresponding public key stored by the service, which can only be decrypted by the public key. Using the pair of private and public keys, the authentication service determines that the computing device is the same device that was previously personalized.

If the device 110 was not previously associated with the user account stored on authentication service 120, then the personalization process discussed above may begin. For example, after the device generates the AC and is subsequently directed to the service, the service may provide the user with an option to personalize that particular device, as discussed with respect to FIGS. 2A, 2B, and 3.

As noted above, as part of the WebAuthN makeCredential and getAttestation workflows, the WebAuthN compliant device challenges the user for presence, as indicated by reference numeral 425, to thereby sign over transaction details and any other proprietary data that the bank may require. This is essentially the same as a payment terminal requesting a user to input a PIN (or sign) as with a traditional EMV scenario. In typical implementations, two-factor authentication such as password and e-mail notification, or biometric sensors for iris scan, fingerprint scan, or facial recognition can be utilized. An attestation statement that the user is authenticated may be generated by the device alongside the payment cryptogram.

Assuming successful user authentication, the device 110 may generate and provide a payment cryptogram 430 to the host 125. The payment cryptogram may authorize the host to receive the funds for the transaction from the service. In this illustrative example, the attestation statement and payment cryptogram are handled in the same workflows. In other implementations, the device may not generate the payment cryptogram until all the various authentication steps have been satisfied. The host then forwards the payment cryptogram to the service, which authorizes payment to the host 435. As an alternative, the device may forward the payment cryptogram to the service, which thereby verifies and provides the funds for the transaction to the host.

FIG. 4B shows an illustrative interaction 450 in which additional security measures may be implemented with the WebAuthN API. For example, the device may transmit additional security information or certificates 455 in addition to the user authentication 420. The service may also include additional security measures/criteria 460 during a transaction. The additional security information may be re-configurable and customizable by the administrator or business that implements the WebAuthN system across the devices. Thus, the configuration of WebAuthN may differ across industries or implementations.

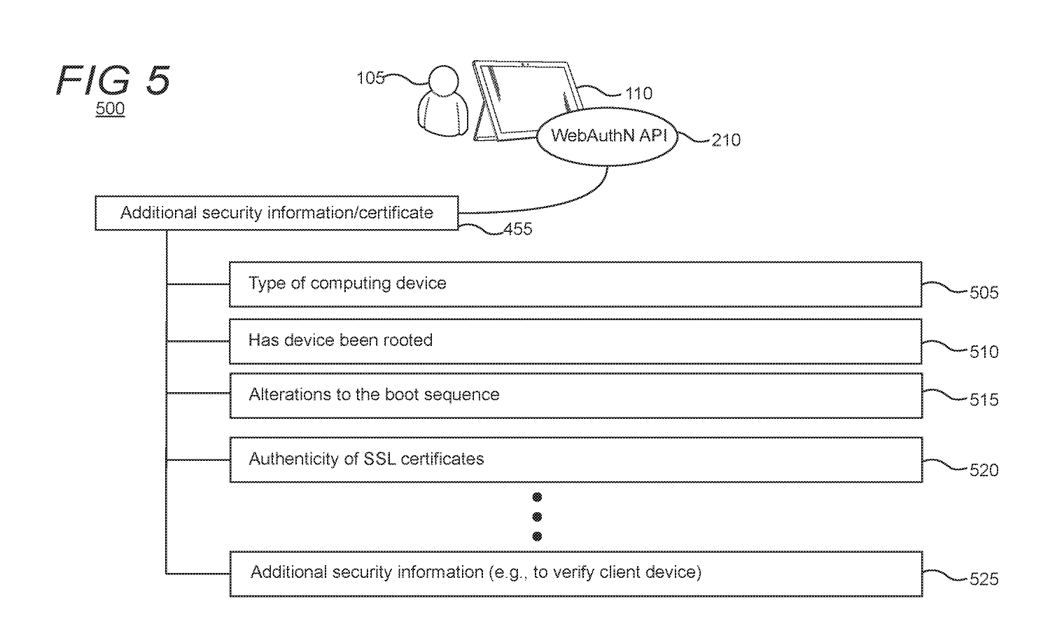

FIG. 5 provides a taxonomy 500 of examples of additional security information/certificates 455. For example, the additional security information can include a type of computing device 505, whether the device has been rooted 510, whether there have been alterations to the device's boot sequence 515, the authenticity of the SSL (secure socket layer) certificates 520, and additional security information to verify the authenticity of the client device 525.

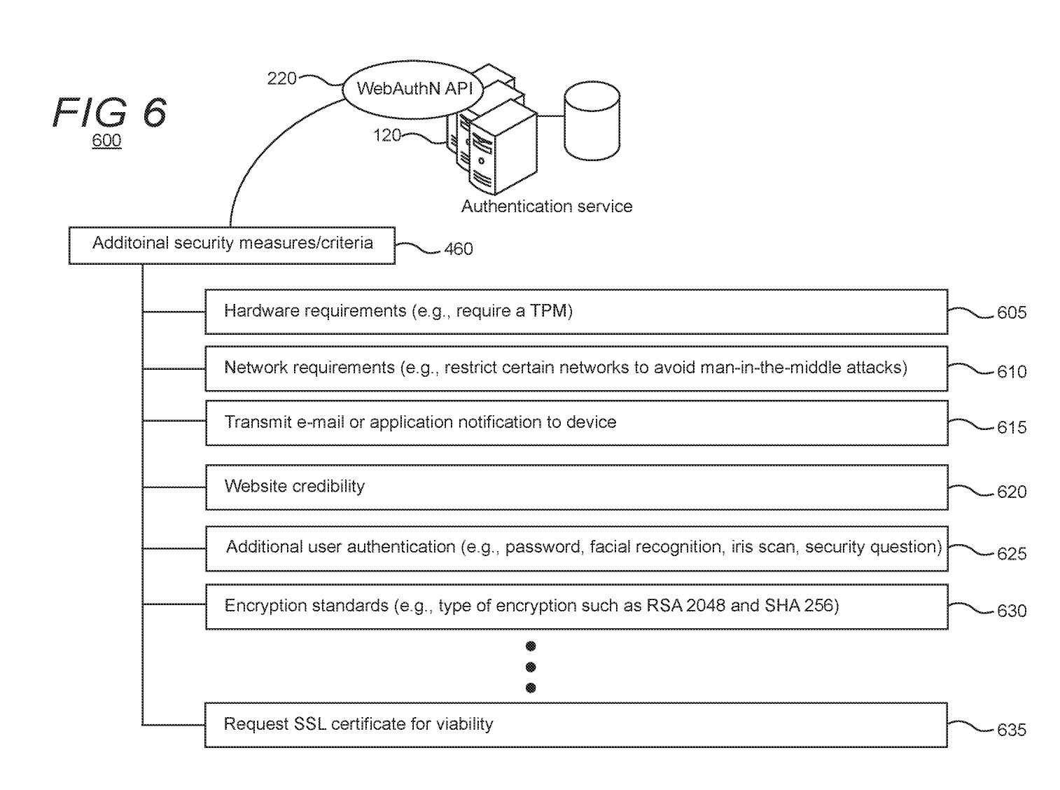

FIG. 6 provides a taxonomy 600 of examples of the additional security criteria 460 that the authentication service 120 may implement across the WebAuthN devices and/or servers. For example, the additional security criteria can include hardware requirements of devices (e.g., require a TPM) 605, network requirements (e.g., restrict certain networks to avoid man-in-the-middle attacks) 610, transmit e-mail or application notifications to devices 615, identify a credibility of a website 620, implement additional user authentication (e.g., password, biometric data) 625, encryption standards (e.g., type of encryption such as RSA 2048 and SHA 256) 630, and request SSL certificate for viability 635.

The additional security information and measures performed at steps 455 and 460 may be constant (e.g., occur each transaction), or may be dynamic. For example, the additional measures may be executed based on potentially suspicious activity and/or periodically. If performed on a periodic basis, this may occur after a pre-set number of transactions (either in total or associated with the particular user account), or after a predetermined amount of time between transactions.

In one exemplary embodiment, if the authentication service identifies that there has been an alteration with the boot sequence of the computing device, then the service may dynamically react to the situation and perform one of the additional steps exemplified in FIG. 6. For example, the service may request an additional authentication step for the user, such as an e-mail confirmation to the user that requires a user response.

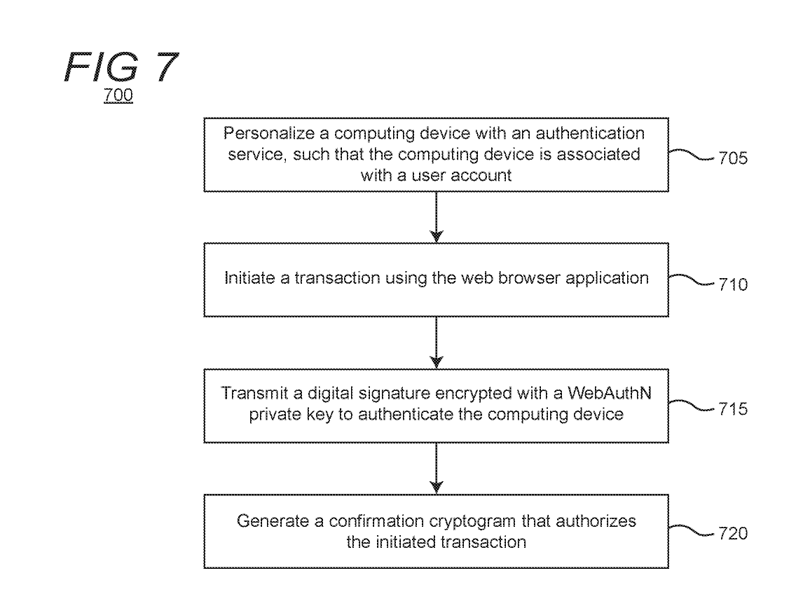

FIG. 7 is a flowchart of an illustrative method 700 to authorize a user for a transaction. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 705, a computing device is personalized with an authentication service. The personalization can include associating the computing device with a user account. In step 710, a transaction is initiated using a web browser application. In step 715, a digital signature that is encrypted is transmitted with a WebAuthN private key. This digital signature may be used to authenticate the computing device. In step 720, a confirmation cryptogram is generated that authorized the initiated transaction.

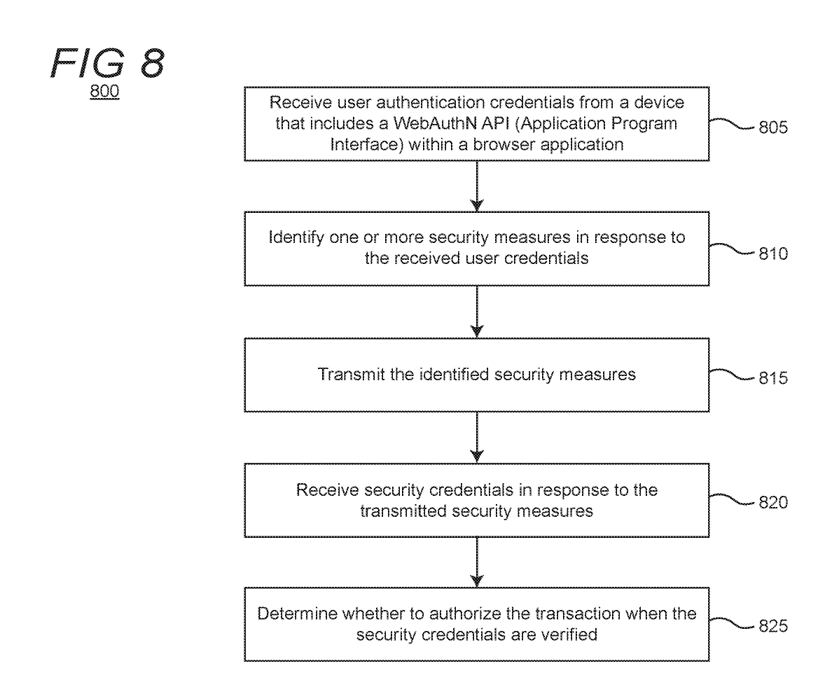

FIG. 8 is a method 800 that may be performed by a remote service. In step 805, user authentication credentials are received from a device that includes a WebAuthN API within a browser application. In step 810, one or more security measures are identified in response to the received user credentials. In step 815, the identified security measures are transmitted. In step 820, security credentials are received in response to the transmitted security measures. In step 825, a determination is made whether to authorize the transaction when the security credentials are verified.

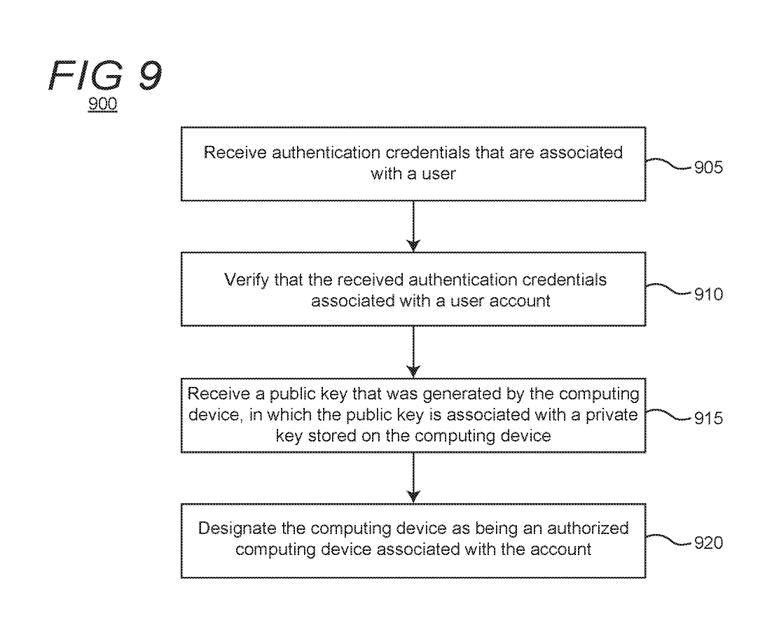

FIG. 9 is a method 900 that may be performed by a remote server. In step 905, authentication credentials are received that are associated with a user. In step 910, the received authentication credentials are verified as being associated with a user account. In step 915, a public key that was generated by a computing device is received. The public key can be associated with a private key stored on the computing device. In step 920, the computing device is designated as being an authorized computing device associated with the account. The remote server may only authorize transactions that originate from authorized computing devices.

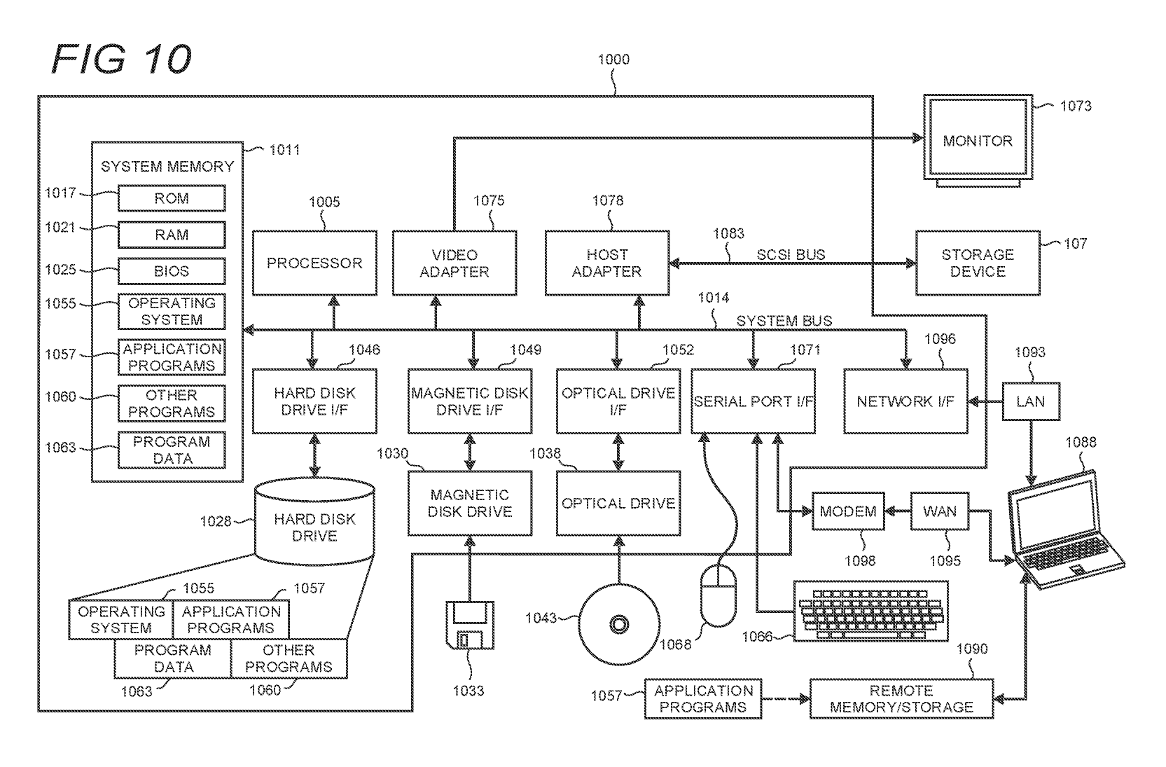

FIG. 10 is a simplified block diagram of an illustrative computer system 1000 such as a PC, client machine, or server with which the present WebAuthN as EMV for purpose of ecommerce is utilized. Computer system 1000 includes a processor 1005, a system memory 1011, and a system bus 1014 that couples various system components including the system memory 1011 to the processor 1005. The system bus 1014 may be any of several types of bus structures including a memory bus or memory controller, a peripheral bus, or a local bus using any of a variety of bus architectures. The system memory 1011 includes read only memory (ROM) 1017 and random access memory (RAM) 1021. A basic input/output system (BIOS) 1025, containing the basic routines that help to transfer information between elements within the computer system 1000, such as during startup, is stored in ROM 1017. The computer system 1000 may further include a hard disk drive 1028 for reading from and writing to an internally disposed hard disk (not shown), a magnetic disk drive 1030 for reading from or writing to a removable magnetic disk 1033 (e.g., a floppy disk), and an optical disk drive 1038 for reading from or writing to a removable optical disk 1043 such as a CD (compact disc), DVD (digital versatile disc), or other optical media. The hard disk drive 1028, magnetic disk drive 1030, and optical disk drive 1038 are connected to the system bus 1014 by a hard disk drive interface 1046, a magnetic disk drive interface 1049, and an optical drive interface 1052, respectively. The drives and their associated computer-readable storage media provide non-volatile storage of computer-readable instructions, data structures, program modules, and other data for the computer system 1000. Although this illustrative example includes a hard disk, a removable magnetic disk 1033, and a removable optical disk 1043, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present WebAuthN as EMV for purpose of ecommerce. In addition, as used herein, the term computer-readable storage media includes one or more instances of a media type (e.g., one or more magnetic disks, one or more CDs, etc.). For purposes of this specification and the claims “computer-readable storage media” and variations thereof are non-transitory and do not include waves, signals, and/or other transitory and/or intangible communication media.

A number of program modules may be stored on the hard disk 1028, magnetic disk 1030, optical disk 1030, ROM 1017, or RAM 1021, including an operating system 1055, one or more application programs 1057, other program modules 1060, and program data 1063. A user may enter commands and information into the computer system 1000 through input devices such as a keyboard 1066 and pointing device 1068 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 1005 through a serial port interface 1071 that is coupled to the system bus 1014, but may be connected by other interfaces, such as a parallel port, game port, or universal serial bus (USB). A monitor 1073 or other type of display device is also connected to the system bus 1014 via an interface, such as a video adapter 1075. In addition to the monitor 1073, personal computers typically include other peripheral output devices (not shown), such as speakers and printers. The illustrative example shown in FIG. 10 also includes a host adapter 1078, a Small Computer System Interface (SCSI) bus 1083, and an external storage device 1076 connected to the SCSI bus 1083.

The computer system 1000 is operable in a networked environment using logical connections to one or more remote computers, such as a remote computer 1088. The remote computer 1088 may be selected as another personal computer, a server, a router, a network PC, a peer device, or other common network node, and typically includes many or all of the elements described above relative to the computer system 1000, although only a single representative remote memory/storage device 1090 is shown in FIG. 10. The logical connections depicted in FIG. 10 include a local area network (LAN) 1093 and a wide area network (WAN) 1095. Such networking environments are often deployed, for example, in offices, enterprise-wide computer networks, intranets, and the Internet.

When used in a LAN networking environment, the computer system 1000 is connected to the local area network 1093 through a network interface or adapter 3196. When used in a WAN networking environment, the computer system 1000 typically includes a broadband modem 1098, network gateway, or other means for establishing communications over the wide area network 1095, such as the Internet. The broadband modem 1098, which may be internal or external, is connected to the system bus 1014 via a serial port interface 1071. In a networked environment, program modules related to the computer system 1000, or portions thereof, may be stored in the remote memory storage device 1090. It is noted that the network connections shown in FIG. 10 are illustrative and other methods of establishing a communications link between the computers may be used depending on the specific requirements of an application of the present WebAuthN as EMV for purpose of ecommerce.

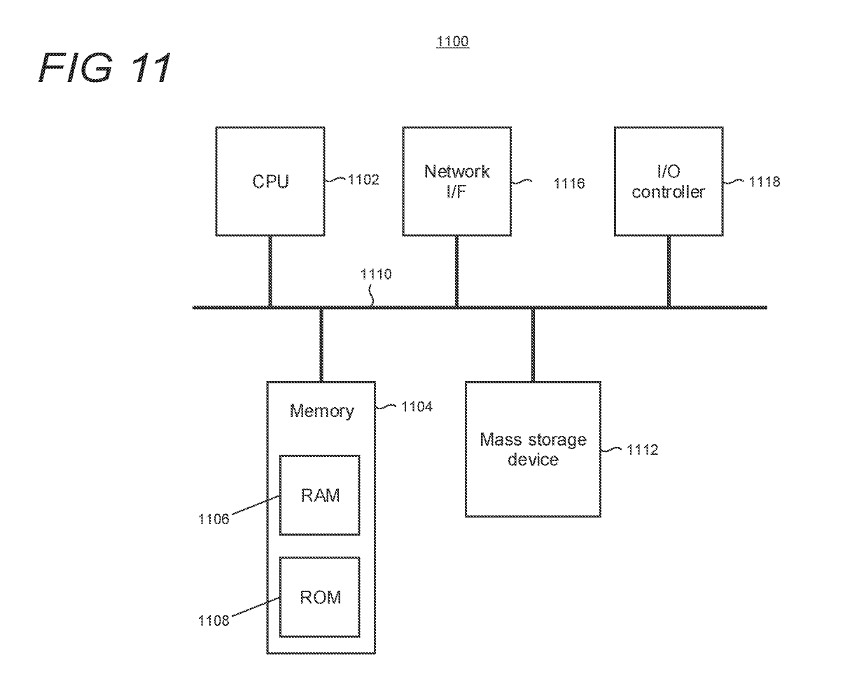

FIG. 11 shows an illustrative architecture 1100 for a device capable of executing the various components described herein for user and device authentication for web applications. Thus, the architecture 1100 illustrated in FIG. 11 shows an architecture that may be adapted for a server computer, mobile phone, a PDA, a smartphone, a desktop computer, a netbook computer, a tablet computer, GPS device, gaming console, and/or a laptop computer. The architecture 1100 may be utilized to execute any aspect of the components presented herein.

The architecture 1100 illustrated in FIG. 11 includes a CPU (Central Processing Unit) 1102, a system memory 1104, including a RAM 1106 and a ROM 1108, and a system bus 1110 that couples the memory 1104 to the CPU 1102. A basic input/output system containing the basic routines that help to transfer information between elements within the architecture 1100, such as during startup, is stored in the ROM 1108. The architecture 1100 further includes a mass storage device 1112 for storing software code or other computer-executed code that is utilized to implement applications, the file system, and the operating system.

The mass storage device 1112 is connected to the CPU 1102 through a mass storage controller (not shown) connected to the bus 1110. The mass storage device 1112 and its associated computer-readable storage media provide non-volatile storage for the architecture 1100.

Although the description of computer-readable storage media contained herein refers to a mass storage device, such as a hard disk or CD-ROM drive, it may be appreciated by those skilled in the art that computer-readable storage media can be any available storage media that can be accessed by the architecture 1100.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1100.

According to various embodiments, the architecture 1100 may operate in a networked environment using logical connections to remote computers through a network. The architecture 1100 may connect to the network through a network interface unit 1116 connected to the bus 1110. It may be appreciated that the network interface unit 1116 also may be utilized to connect to other types of networks and remote computer systems. The architecture 1100 also may include an input/output controller 1118 for receiving and processing input from a number of other devices, including a keyboard, mouse, or electronic stylus (not shown in FIG. 11). Similarly, the input/output controller 1118 may provide output to a display screen, a printer, or other type of output device (also not shown in FIG. 11).

It may be appreciated that the software components described herein may, when loaded into the CPU 1102 and executed, transform the CPU 1102 and the overall architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1100 in order to store and execute the software components presented herein. It also may be appreciated that the architecture 1100 may include other types of computing devices, including handheld computers, embedded computer systems, smartphones, PDAs, and other types of computing devices known to those skilled in the art. It is also contemplated that the architecture 1100 may not include all of the components shown in FIG. 11, may include other components that are not explicitly shown in FIG. 11, or may utilize an architecture completely different from that shown in FIG. 11.

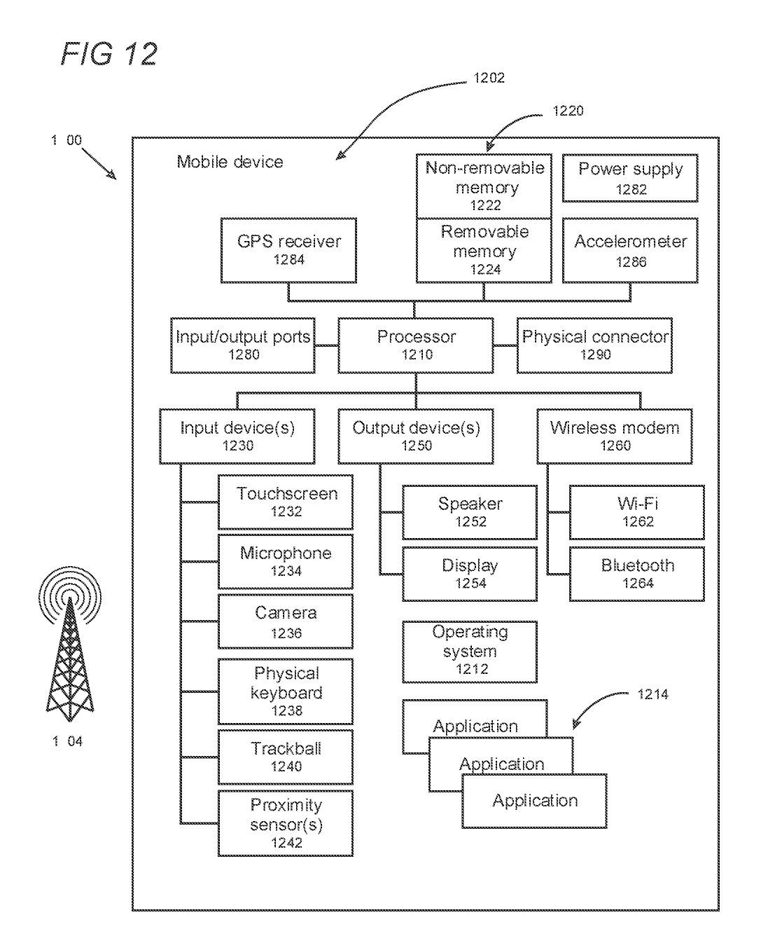

FIG. 12 is a functional block diagram of an illustrative device 1200 such as a mobile phone or smartphone including a variety of optional hardware and software components, shown generally at 1202. Any component 1202 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 1204, such as a cellular or satellite network.

The illustrated device 1200 can include a controller or processor 1210 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 1212 can control the allocation and usage of the components 1202, including power states, above-lock states, and below-lock states, and provides support for one or more application programs 1214. The application programs can include common mobile computing applications (e.g., image-capture applications, e-mail applications, calendars, contact managers, web browsers, messaging applications), or any other computing application.

The illustrated device 1200 can include memory 1220. Memory 1220 can include non-removable memory 1222 and/or removable memory 1224. The non-removable memory 1222 can include RAM, ROM, Flash memory, a hard disk, or other well-known memory storage technologies. The removable memory 1224 can include Flash memory or a Subscriber Identity Module (SIM) card, which is well known in GSM (Global System for Mobile communications) systems, or other well-known memory storage technologies, such as “smart cards.” The memory 1220 can be used for storing data and/or code for running the operating system 1212 and the application programs 1214. Example data can include web pages, text, images, sound files, video data, or other data sets to be sent to and/or received from one or more network servers or other devices via one or more wired or wireless networks.

The memory 1220 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the device 1200.

The memory 1220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The device 1200 can support one or more input devices 1230; such as a touchscreen 1232; microphone 1234 for implementation of voice input for voice recognition, voice commands and the like; camera 1236; physical keyboard 1238; trackball 1240; and/or proximity sensor 1242; and one or more output devices 1250, such as a speaker 1252 and one or more displays 1254. Other input devices (not shown) using gesture recognition may also be utilized in some cases. Other possible output devices (not shown) can include piezoelectric or haptic output devices. Some devices can serve more than one input/output function. For example, touchscreen 1232 and display 1254 can be combined into a single input/output device.

A wireless modem 1260 can be coupled to an antenna (not shown) and can support two-way communications between the processor 1210 and external devices, as is well understood in the art. The modem 1260 is shown generically and can include a cellular modem for communicating with the mobile communication network 1204 and/or other radio-based modems (e.g., Bluetooth 1264 or Wi-Fi 1262). The wireless modem 1260 is typically configured for communication with one or more cellular networks, such as a GSM network for data and voice communications within a single cellular network, between cellular networks, or between the device and a public switched telephone network (PSTN).

The device can further include at least one input/output port 1280, a power supply 1282, a satellite navigation system receiver 1284, such as a GPS receiver, an accelerometer 1286, a gyroscope (not shown), and/or a physical connector 1290, which can be a USB port, IEEE 1394 (FireWire) port, and/or an RS-232 port. The illustrated components 1202 are not required or all-inclusive, as any components can be deleted and other components can be added.

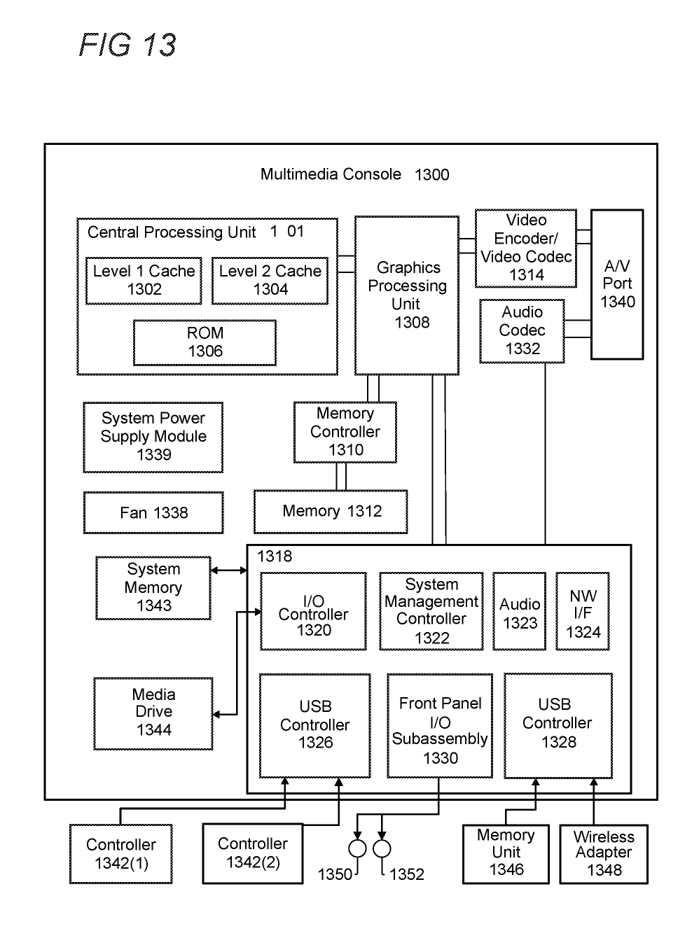

FIG. 13 is an illustrative functional block diagram of a multimedia console 1300. The multimedia console 1300 has a central processing unit (CPU) 1301 having a level 1 cache 1302, a level 2 cache 1304, and a Flash ROM (Read Only Memory) 1306. The level 1 cache 1302 and the level 2 cache 1304 temporarily store data and hence reduce the number of memory access cycles, thereby improving processing speed and throughput. The CPU 1301 may be configured with more than one core, and thus, additional level 1 and level 2 caches 1302 and 1304. The Flash ROM 1306 may store executable code that is loaded during an initial phase of a boot process when the multimedia console 1300 is powered ON.

A graphics processing unit (GPU) 1308 and a video encoder/video codec (coder/decoder) 1314 form a video processing pipeline for high speed and high resolution graphics processing. Data is carried from the GPU 1308 to the video encoder/video codec 1314 via a bus. The video processing pipeline outputs data to an A/V (audio/video) port 1340 for transmission to a television or other display. A memory controller 1310 is connected to the GPU 1308 to facilitate processor access to various types of memory 1312, such as, but not limited to, a RAM.

The multimedia console 1300 includes an I/O controller 1320, a system management controller 1322, an audio processing unit 1323, a network interface controller 1324, a first USB (Universal Serial Bus) host controller 1326, a second USB controller 1328, and a front panel I/O subassembly 1330 that are preferably implemented on a module 1318. The USB controllers 1326 and 1328 serve as hosts for peripheral controllers 1342(1) and 1342(2), a wireless adapter 1348, and an external memory device 1346 (e.g., Flash memory, external CD/DVD ROM drive, removable media, etc.). The network interface controller 1324 and/or wireless adapter 1348 provide access to a network (e.g., the Internet, home network, etc.) and may be any of a wide variety of various wired or wireless adapter components including an Ethernet card, a modem, a Bluetooth module, a cable modem, or the like.

System memory 1343 is provided to store application data that is loaded during the boot process. A media drive 1344 is provided and may comprise a DVD/CD drive, hard drive, or other removable media drive, etc. The media drive 1344 may be internal or external to the multimedia console 1300. Application data may be accessed via the media drive 1344 for execution, playback, etc. by the multimedia console 1300. The media drive 1344 is connected to the I/O controller 1320 via a bus, such as a Serial ATA bus or other high speed connection (e.g., IEEE 1394).

The system management controller 1322 provides a variety of service functions related to assuring availability of the multimedia console 1300. The audio processing unit 1323 and an audio codec 1332 form a corresponding audio processing pipeline with high fidelity and stereo processing. Audio data is carried between the audio processing unit 1323 and the audio codec 1332 via a communication link. The audio processing pipeline outputs data to the A/V port 1340 for reproduction by an external audio player or device having audio capabilities.

The front panel I/O subassembly 1330 supports the functionality of the power button 1350 and the eject button 1352, as well as any LEDs (light emitting diodes) or other indicators exposed on the outer surface of the multimedia console 1300. A system power supply module 1339 provides power to the components of the multimedia console 1300. A fan 1338 cools the circuitry within the multimedia console 1300.

The CPU 1301, GPU 1308, memory controller 1310, and various other components within the multimedia console 1300 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 1300 is powered ON, application data may be loaded from the system memory 1343 into memory 1312 and/or caches 1302 and 1304 and executed on the CPU 1301. The application may present a graphical user interface that provides a consistent user experience when navigating to different media types available on the multimedia console 1300. In operation, applications and/or other media contained within the media drive 1344 may be launched or played from the media drive 1344 to provide additional functionalities to the multimedia console 1300.

The multimedia console 1300 may be operated as a standalone system by simply connecting the system to a television or other display. In this standalone mode, the multimedia console 1300 allows one or more users to interact with the system, watch movies, or listen to music. However, with the integration of broadband connectivity made available through the network interface controller 1324 or the wireless adapter 1348, the multimedia console 1300 may further be operated as a participant in a larger network community.

When the multimedia console 1300 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 1300 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 1301 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 1342(1) and 1342(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

Various exemplary embodiments of the present user and device authentication for web applications are now presented by way of illustration and not as an exhaustive list of all embodiments. An example includes a method performed on a computing device with a web browser application which is configured with a WebAuthN API (application program interface), the computing device having access to a network, the method comprising: personalizing the computing device with an authentication service, wherein the personalizing includes associating the computing device with a user account; initiating a transaction using the web browser application; transmitting a digital signature encrypted with a WebAuthN private key to authenticate the computing device; and generating a confirmation cryptogram that authorizes the initiated transaction.

In another example, the transaction is initiated at a website accessed by the web browser application, and the authentication service is unassociated with the website. In another example, the method further comprises: providing an attestation challenge to verify authenticity of a user; and receiving an attestation response in response to the attestation challenge. In another example, the attestation challenge includes one or more of a PIN (personal identification number), password, pattern input, or biometric data including fingerprint verification, iris scan, or facial recognition. In another example, the generated confirmation cryptogram is transmitted to one of a server associated with the website or the authentication service. In another example, the generated confirmation cryptogram includes details about the transaction. In another example, the method further comprises configuring the WebAuthN API of the web browser application to include providing additional security information to the authentication service that is separate from the digital signature. In another example, the additional security information includes one or more of a type of computing device, whether the computing device has been rooted, alterations to a boot sequence of the computing device, or verification of secure socket layer (SSL) certificates. In another example, the WebAuthN API of the web browser application is re-configurable such that the additional security information provided to the authentication service is customizable based on proprietary programming. In another example, the method further comprises receiving additional security criteria from the authentication service, the additional security criteria including hardware requirements, network requirements, e-mail notification, application notification, website credibility, additional user authentication, encryption standards, or secure socket layer (SSL) check. In another example, the personalizing includes establishing the WebAuthN private key and a WebAuthN public key, in which the private key is stored in a secure cryptoprocessor, including a trusted platform module (TPM).

A further example includes a computing server having connectivity to a network and a WebAuthN API (application program interface), comprising: one or more processors; memory storing computer-readable instructions which, when executed by the one or more processors, perform a method comprising the steps of: receive user authentication credentials from a device that includes a WebAuthN API within a browser application; identify one or more security measures in response to the received user credentials; transmit the identified security measures; receive security credentials in response to the transmitted security measures; and determine whether to authorize the transaction when the security credentials are verified.

In another example, the security measures are configurable such that the security measures are customizable based on proprietary programming. In another example, the customizable security measures include one or more of hardware requirements, network requirements, transmitting an e-mail or notification to the device, credibility of website interacting with device, additional user authentication, setting an encryption standard, or requesting SSL (secure socket layer) certificate viability. In another example, the computing server further comprises transmitting an attestation challenge to verify an authenticity of a user device, in which the attestation challenge is separate from the additional security measures.

A further example includes one or more computer-readable memory devices storing instructions which, when executed by one or more processors disposed in a computer server, cause the computer server to: receive authentication credentials associated with a user; verify that the received authentication credentials are associated with a user account; receive a public key that was generated by the computing device, wherein the public key is associated with a private key stored on the computing device; and designate the computing device as being an authorized computing device associated with the account, wherein the computer server only authorizes transactions from authorized computing devices.

In another example, the one or more processors further cause the computer server to identify an additional computing device as an authorized computing device. In another example, the computing device, the additional computing device, and the computer server include a WebAuthN API (Application Program Interface) that allows the computer server to establish and identify authorized computing devices. In another example, the WebAuthN API utilizes an encryption standard that is customizable. In another example, the computer server provides authorization for a transaction to be completed to one or more of the computing device or a remote server with which the computing device has interacted.

Based on the foregoing, it may be appreciated that technologies for user and device authentication for web applications have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and is not to be construed as limiting. Various modifications and changes may be made to the subject matter described herein without following the example embodiments and applications illustrated and described, and without departing from the true spirit and scope of the present invention, which is set forth in the following claims.

What is claimed:

1. A method performed on a computing device with a web browser application which is configured with a WebAuthN API (application program interface), the computing device having access to a network, the method comprising:
personalizing the computing device with an authentication service, wherein the personalizing includes associating the computing device with a user account;
initiating a transaction using the web browser application;
transmitting a digital signature encrypted with a WebAuthN private key to authenticate the computing device; and
generating a confirmation cryptogram that authorizes the initiated transaction.

2. The method of claim 1, wherein the transaction is initiated at a website accessed by the web browser application, and the authentication service is unassociated with the website.

3. The method of claim 2, further comprising:
providing an attestation challenge to verify authenticity of a user; and
receiving an attestation response in response to the attestation challenge.

4. The method of claim 3, wherein the attestation challenge includes one or more of a PIN (personal identification number), password, pattern input, or biometric data including fingerprint verification, iris scan, or facial recognition.

5. The method of claim 2, wherein the generated confirmation cryptogram is transmitted to one of a server associated with the website or the authentication service.

6. The method of claim 5, wherein the generated confirmation cryptogram includes details about the transaction.

7. The method of claim 1, further comprising configuring the WebAuthN API of the web browser application to include providing additional security information to the authentication service that is separate from the digital signature.

8. The method of claim 7, wherein the additional security information includes one or more of a type of computing device, whether the computing device has been rooted, alterations to a boot sequence of the computing device, or verification of secure socket layer (SSL) certificates.

9. The method of claim 7, wherein the WebAuthN API of the web browser application is re-configurable such that the additional security information provided to the authentication service is customizable based on proprietary programming.

10. The method of claim 1, further comprising receiving additional security criteria from the authentication service, the additional security criteria including hardware requirements, network requirements, e-mail notification, application notification, website credibility, additional user authentication, encryption standards, or secure socket layer (SSL) check.

11. The method of claim 1, wherein the personalizing includes establishing the WebAuthN private key and a WebAuthN public key, in which the private key is stored in a secure cryptoprocessor, including a trusted platform module (TPM).

12. A computing server having connectivity to a network and a WebAuthN API (application program interface), comprising:
one or more processors;
memory storing computer-readable instructions which, when executed by the one or more processors, perform a method comprising the steps of:
receive user authentication credentials from a device that includes a WebAuthN API within a browser application;
identify one or more security measures in response to the received user credentials;
transmit the identified security measures;
receive security credentials in response to the transmitted security measures; and
determine whether to authorize a transaction when the security credentials are verified.

13. The computing server of claim 12, wherein the security measures are configurable such that the security measures are customizable based on proprietary programming.

14. The computing server of claim 13, wherein the customizable security measures include one or more of hardware requirements, network requirements, transmitting an e-mail or notification to the device, credibility of website interacting with device, additional user authentication, setting an encryption standard, or requesting SSL (secure socket layer) certificate viability.

15. The computing server of claim 12, further comprising transmitting an attestation challenge to verify an authenticity of a user device, in which the attestation challenge is separate from the additional security measures.

16. One or more computer-readable memory devices storing instructions which, when executed by one or more processors disposed in a computer server, cause the computer server to:
receive authentication credentials associated with a user;
verify that the received authentication credentials are associated with a user account;
receive a public key that was generated by the computing device, wherein the public key is associated with a private key stored on the computing device; and
designate the computing device as being an authorized computing device associated with the account,
wherein the computer server only authorizes transactions from authorized computing devices.

17. The one or more computer-readable memory devices of claim 16, wherein the one or more processors further cause the computer server to identify an additional computing device as an authorized computing device.

18. The one or more computer-readable memory devices of claim 17, wherein the computing device, the additional computing device, and the computer server include a WebAuthN API (Application Program Interface) that allows the computer server to establish and identify authorized computing devices.

19. The one or more computer-readable memory devices of claim 18, wherein the WebAuthN API utilizes an encryption standard that is customizable.

20. The one or more computer-readable memory devices of claim 16, wherein the computer server provides authorization for a transaction to be completed to one or more of the computing device or a remote server with which the computing device has interacted.
